(19) United States
(12) Patent Application Publication
(10) Pub. No.: US 2015/0070447 A1
(43) Pub. Date: Mar. 12, 2015

(54) LIQUID CONTAINER

(71) Applicant: SEIKO EPSON CORPORATION, TOKYO (JP)

(72) Inventors: Hiroshi NOSE, Shiojiri (JP); Kazuyuki HIRATA, Matsumoto (JP); Yuji AOKI, Matsumoto (JP)

(21) Appl. No.: 14/476,193

(22) Filed: Sep. 3, 2014

(30) Foreign Application Priority Data
Sep. 12, 2013 (JP) 2013-189111

(51) Int. Cl. B41J 2/175

(52) U.S. Cl. CPC B41J 2/17503
USPC 347/86

(57) ABSTRACT

The liquid container includes a liquid containing body having a flexible bag-shaped liquid containing section configured to contain liquid and a supply member that is connected to the liquid containing section and has a supply port configured to supply the liquid from the liquid containing section to an outside, and a case member configured to contain the liquid containing body. The case member has a first surface in which an opening section is formed to expose the supply port, and a second surface opposed to the first surface. The case member further has opposing sections that are opposed through the liquid containing section and are configured to contact with the liquid containing section in a position of a +Y-direction, which is a direction from the first surface to the second surface, than a joint section between the liquid containing section and the supply member.

### CROSS-REFERENCE TO RELATED APPLICATIONS

This application claims priority to Japanese Patent Application No. 2013-189111 filed on Sep. 12, 2013. The entire disclosure of Japanese Patent Application No. 2013-189111 is hereby incorporated herein by reference.

### BACKGROUND

1. Technical Field

The present invention relates to a liquid container that a liquid containing body in which a supply member having a supply port capable of supplying liquid from the inside of a liquid containing section to outside is connected to a flexible bag-shaped liquid containing section is stored in a case member.

2. Related Art

Generally, in an ink-jet type printer (liquid ejecting device) that ejects ink (liquid), an ink cartridge (liquid container) storing the ink is detachably mounted. The printer performs a printing by ejecting the ink, which is supplied from the mounted ink cartridge, to a target such as a paper, etc. As an example of such ink cartridge, it is well-known an ink cartridge that an ink pack (liquid containing body), which is provided with a flexible bag (liquid containing section) capable of storing the ink and a supply member capable of supplying the ink from the inside of the bag to the outside by connecting an opening edge of the bag, is stored the inside of the rectangular-shaped case member (see Japanese Laid-open Patent Application Publication No. 2012-140011).

In the aforementioned ink cartridge, in the state that the ink pack is stored in the case member, there exists a gap between the outer surface of the ink pack and the inner surface of the case member. Therefore, in a case that the ink cartridge is fallen down, etc., the ink pack is oscillated. The ink in the ink pack is also oscillated in accordance with the oscillation of the ink pack. A joint section between the inner surface of the opening edge of the bag in the ink pack and the outer surface of the supply member is peeled off by the oscillation of the ink, and as a result that the ink is leaked from the inside of the bag, there is a possibility that the ink amount, which is essentially usable by the user, is reduced, or the ink cannot be supplied to the printer.

It is not limited to the ink cartridge mounted in the printer, but such condition is generally common in the liquid container that the liquid containing body in which the flexible bag-shaped liquid containing section is connected to the supply member for supplying liquid from the inside of the liquid containing section to the outside is stored.

### SUMMARY

With the consideration of the current situation, an object of the present invention is to provide a liquid container that can suppress a case that the liquid amount for supplying from the inside of the liquid containing body contained in the case member to the outside is reduced, or a case that the liquid cannot be supplied to the liquid ejecting device.

Hereinafter, means for solving the aforementioned problems and its functions and effects will be described.

A liquid container that solves the aforementioned problems includes a liquid containing body and the case member. The liquid containing body includes a liquid containing section configured to contain liquid, the liquid containing section being flexible and having a bag-shape, and a supply member connected to the liquid containing section, the supply member having a supply port that is configured to supply the liquid from the liquid containing section to an outside. The case member is configured to contain the liquid containing body. The case member has a first surface in which an opening section is formed to expose the supply port, and a second surface opposed to the first surface. When a direction in which the first surface and the second surface are opposed is a Y-direction, and a direction from the first surface to the second surface is a +Y-direction, the case member further has opposing sections that are opposed through the liquid containing section and are configured to contact with the liquid containing section in a position of the +Y-direction than a joint section between the liquid containing section and the supply member.

For example, when an impact is given due to the falling-down of the liquid container, etc., there is a case that the liquid containing body contained in the case member is oscillated. When the liquid is oscillated in accordance with the oscillation of the liquid containing body, there is a possibility that the joint section between the liquid containing section and the supply member is peeled off. However, the opposing section and the liquid containing body are contacted in the +Y-direction than the joint section. With this structure, the propagation of the impact given to the joint section by the oscillation of the liquid container or the liquid is suppressed. Therefore, it is suppressed beforehand and it prevents the joint section from peeling off which causes the leakage of the liquid from inside of the liquid containing body so that the case that the liquid amount for supplying from the inside of the liquid containing body contained in the case member to the outside is efficiently reduced is suppressed, or the case that the liquid cannot be supplied to the liquid ejecting device can be suppressed.

In the aforementioned liquid container, it is preferable that the shape of the opposing sections is a circular arc.

With this structure, even though the opposing sections are contacted to the liquid containing body, the damage to the liquid containing body can be reduced since the shape of the opposing sections is a circular arc. As a result, a possibility that the liquid is leaked out due to the breakage, etc. of the liquid containing body can be suppressed.

In the aforementioned liquid container, it is preferable that the opposing sections are configured to contact with the liquid containing section in at least a part including a position overlapped with the joint section in the +Y-direction.

With such structure, even if the liquid in the inside of the liquid containing section flows toward the direction of the joint section between the liquid containing section and the supply member along the inner surface of the liquid containing section, the entire flow of liquid directly hitting into the joint section can be blocked by the opposing section provided in the position overlapping with the joint section in the +Y direction. Therefore, the easiness of peeling off the joint section can be suppressed by directly hitting such entire flow of liquid in the manner of demonstrating the wedge effect for the joint section.

In the aforementioned liquid container, the case member has four surfaces that are a third surface, a fourth surface, a fifth surface, and a sixth surface that intersect with the first surface and the second surface, and the opposing sections protrudes to a side of the liquid containing section from two surfaces intersecting with a gravity direction, among the four surfaces.

With such structure, it can be stably supported in the state that the liquid containing section, which has the flexible liquid containing body in the case member, is sandwiched from the both sides in the direction intersecting with the gravity direction.

In the aforementioned liquid container, in the case member, in a position of the liquid container in use, a contact section, which is capable of supporting the liquid containing section, is preferably provided in a state that a surface, which is inclined with respect to the gravity direction, is provided and the surface is contacted to the liquid containing section of the liquid containing body contained in the case member from a direction opposed to the gravity direction.

For example, there is a case that a bag-shape of the liquid containing section is formed by welding peripheral edges of two flexible sheet materials except an opening edge that is contacted with the supply member. In this case, when the liquid containing section is changed in a manner of crushing the swelling shape in accordance with the supply of the liquid to outside, a bend section, which causes the increase of the remaining amount, may be provided depending on the way of crushing. In this point, according to the aforementioned structure, it makes hard to provide the bend section in the liquid containing section by contacting the inclined surface of the contact section, which is inclined with respect to the gravity direction and is provided in the inside of the case member, to the outer surface of the flexible liquid containing section from the direction opposed to the gravity direction. Therefore, the occurrence of such bend section is suppressed beforehand so that unexpected reduction of the liquid amount for supplying from the inside of the liquid containing body contained in the case member to the outside can be suppressed.

Further, likewise, a liquid container that solves the aforementioned problems includes a liquid containing body in which a supply member is connected to a liquid containing section configured to contain liquid, the liquid containing section being flexible and having a bag-shape, the supply member having a supply port configured to supply the liquid to an outside from an inside of the liquid containing section, and a case member configured to contain the liquid containing body. In the case member, the liquid containing body is contained in a manner that a joint section between the liquid containing section and the supply member is positioned away from an inner surface of the case member, and an oscillation suppressing section is provided toward an outer surface of the liquid containing section in a protruding condition. The oscillation suppressing section is configured to suppress an oscillation of the liquid containing section in the case member by contacting a part of an outer surface positioned in an opposite side of the supply port of the supply member as viewed from the joint section in the liquid containing section of the contained liquid containing body.

With this structure, for example, when the impact is given to the liquid container due to the falling-down of the liquid container, etc., in the liquid containing body contained in the case member, the oscillation in the case member is suppressed by contacting the oscillation suppressing section to a part of the outer surface, which is the part other than the joint section contacted with the supply member in the liquid containing section. Therefore, the peeling-off of the joint section between the liquid containing section and the supply member, which is caused by the oscillation of the liquid containing section, is suppressed. Also, in the case member, the joint section between the liquid containing section and the supply member is away from the inner surface of the case member so that it cannot be peeled off by the impact in a case of hitting the inner surface of the case member. Therefore, the leakage of the liquid from such peeled off portion in the liquid containing section can be avoided. Accordingly, unexpected reduction of the liquid amount for supplying from the liquid containing body contained in the case member to the outside can be suppressed.

Further, likewise, the liquid container that solves the aforementioned problems includes a liquid containing body including a liquid containing section configured to contain liquid, the liquid containing section being flexible and having a bag-shape, and a supply member having a flow channel configured to allow the liquid to flow and configured to supply the liquid from an inside of the liquid containing section to an outside by connecting with the liquid containing section in a state that the flow channel is arranged in a manner of striding over the inside and outside of the liquid containing section, and a case member configured to contain the liquid containing body and having an opening section to expose, to an outside, one end of the flow channel in the supply member of the contained liquid containing body. In the case member, the liquid containing body is contained in a manner that a joint section between the liquid containing section and the supply member is positioned away from an inner surface of the case member, and an oscillation suppressing section is provided toward an outer surface of the liquid containing section in a protruding condition, the oscillation suppressing section being configured to suppress an oscillation of the liquid containing section in the case member by contacting a part other than the joint section in the liquid containing section of the contained liquid containing body.

Also, with such structure, the benefit of functions and effects can be obtained in the same manner as the case of the aforementioned liquid container.

### BRIEF DESCRIPTION OF THE DRAWINGS

Referring now to the attached drawings which form a part of this original disclosure:

FIG. 1 is a perspective view of a printer of the first embodiment;

FIG. 2 is a perspective view of an ink cartridge;

FIG. 3 is an exploded perspective view of the ink cartridge;

FIG. 4 is an exploded perspective view of the ink cartridge in a viewing angle different from FIG. 3;

FIG. 5A is a front view of a supply member;

FIG. 5B is a back view of the supply member;

FIG. 6A is a front view of an ink pack;

FIG. 6B is a partial cross-sectional view of an essential part of the ink pack;

FIG. 7A is a front view of a case member;

FIG. 7B is a cross-sectional view taken along line 7b-7b in FIG. 7A;

FIG. 8A is a cross-sectional view taken along line 8b-8b in FIG. 7A;

FIG. 8B is a case member;

FIG. 9A is a front view schematically showing an essential part of the ink cartridge;

FIG. 9B is a cross-sectional view taken along line 9b-9b in FIG. 9A;

FIG. 10A is a cross-sectional view taken along line 10a-10a in FIG. 2; and

FIG. 10B is a cross-sectional view taken along line 10b-10b in FIG. 2.

### DETAILED DESCRIPTION OF EXEMPLARY EMBODIMENTS

Hereinafter, one embodiment of an ink cartridge (one example of a liquid container) that stores the ink (an example of liquid), and an ink-jet type printer (one example of liquid ejecting device) that ejects the ink supplied from the ink cartridge will be described in reference to the drawings.

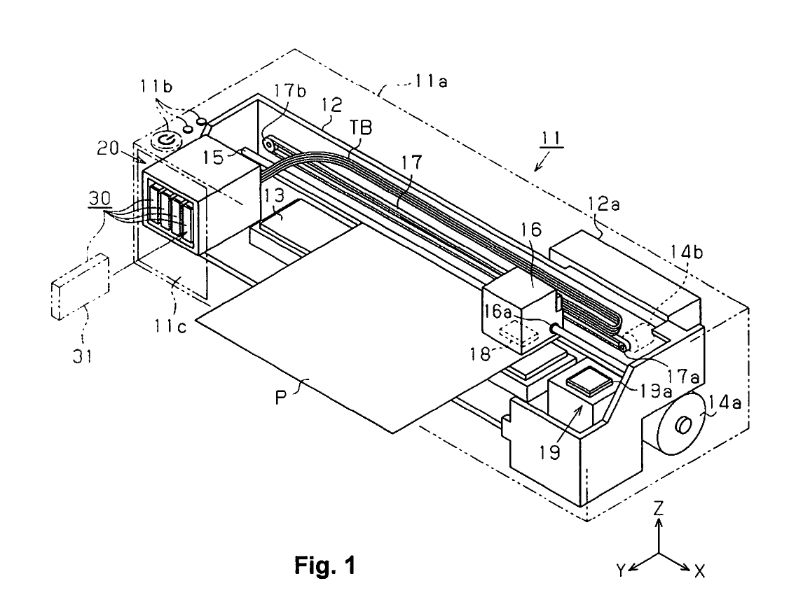

As shown in FIG. 1, a printer 11 of the present embodiment is provided with an approximately rectangular shape housing 11a and its part is shown in a two-dot chain line. In a surface in the +Z-direction side, which is the direction opposed to the gravity direction (−Z direction) in the housing 11a, that is, an upper surface, operation buttons 11b such as a power button, etc. to drive the printer 11 are provided. Also, in a surface in the +Y-direction side, which is a conveying direction that conveys a paper (one example of a target) P in the housing 11a, that is, a front surface, a cover 11c, which enables to open and close, is provided. The user can access to the inside of the housing 11a in a state the cover 11c is opened.

An approximately rectangular box shape frame 12 is contained in the housing 11a. In the lower part that is the gravity direction (−Z-direction) side in the frame 12, a support base 13 that the X-direction, which intersects with the +Y-direction that is the conveying direction of the paper P, is defined as the longitudinal direction is provided extending to the approximately horizontal direction. Further, a paper feeding motor 14a is provided in the lower part of the back side, which is the direction (−Y-direction) opposed to the +Y-direction that is the front side in the frame 12. That is, by the paper feeding mechanism (not shown) driven by the paper feeding motor 14a, the paper P is conveyed from the back side to the front side on the support base 13.

Further, in the upper side of the support base 13 in the frame 12, a guide shaft 15 is provided bridging along the X direction, which is the longitudinal direction of the support base 13. In the guide shaft 15, the carriage 16 is supported in a manner of being capable of reciprocating along the direction of axis. That is, a bearing hole 16a is formed through in a right-and-left direction along the X-direction in the carriage 16, and a guide shaft 15 is introduced through the bearing hole 16a.

Further, in the back wall inner surface of the frame 12, a drive pulley 17a and a driven pulley 17b are respectively and rotatably supported in the vicinity of the both ends of the guide shaft 15. In the drive pulley 17a, an output axis of the carriage motor 14b is connected. Also, an endless timing belt 17, which is partially connected to the carriage 16, is wound between the drive pulley 17a and the driven pulley 17b. By driving the carriage motor 14b, the carriage 16 is guided by the guide shaft 15 through the timing belt 17, and is reciprocated in the right-and-left direction along the X-direction as a scanning direction.

In the lower side of the carriage 16, the liquid ejecting head 18, which is ejectable ink, is provided. The ink is supplied to the liquid ejecting head 18, and by ejecting the supplied ink from the liquid ejecting head 18, an image is printed on the paper P. The supply of the ink to the liquid ejecting head 18 is performed by the ink cartridge (one example of liquid container) which is inserted into/removed from an installation section 20 provided in the housing 11a. That is, in the housing 11a, the installation section 20 in which the ink cartridge 30 can be inserted into/removed from is arranged in the left side area of the right-and-left direction along the X-direction intersecting with the +Y-direction, which is the conveying direction of the paper P. Also, a flexible ink supplying tube TB, which can flow the ink, is pulled around between the installation section 20 and the carriage 16. The ink is supplied to the liquid ejecting head 18 from the ink cartridge 30 mounted on the installation section 20 through the ink supplying tube TB.

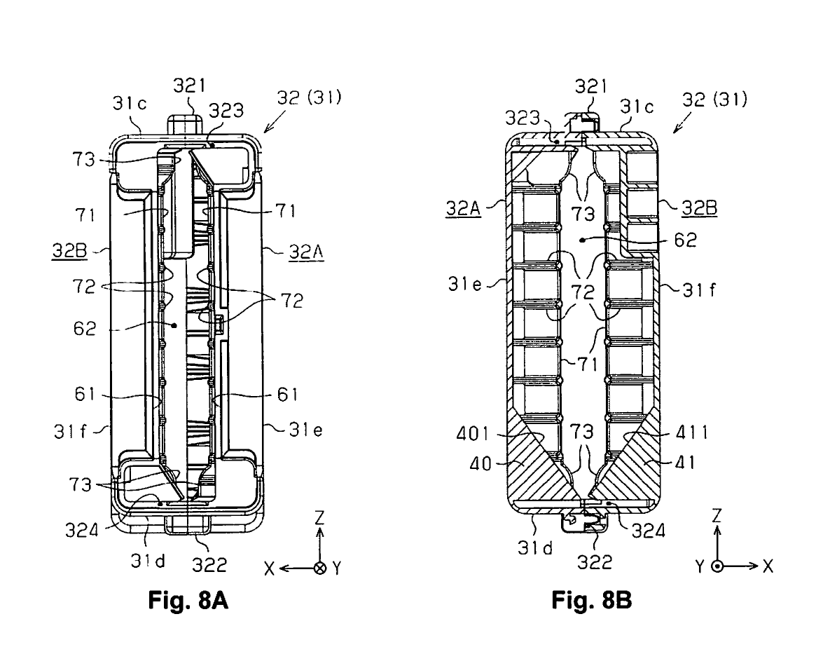

In the present embodiment, four ink cartridges 30, for example, ink pack 50 (see FIG. 8A), which is one example of the liquid containing body that each color ink of cyan, magenta, yellow, black of different hue each other is contained in a rectangular-shaped case member 31, can be mounted in the installation section 20. Each ink cartridge 30 can be inserted into/removed from the installation section 20 along the Y-direction in a state that the cover 11c is opened, and one of them is shown by the two-dot chain line in FIG. 1.

Further, in the right side (+X-direction side) area of the right-and-left direction along the X-direction when viewing from the +Y-direction side, which is the conveying direction than the support base 13 in the inner part of the frame 12, that is, a home position area when the printing is not performed, a maintenance device 19 is provided. The maintenance device 19 is provided with a cap 19a, which opens upper side, and a suction pump, etc. (not shown). In the printer 11, after the carriage 16 was moved in the home position area, by the maintenance device 19, the maintenance operation is performed so that the ink is stably ejected from the liquid ejecting head 18.

Next, the schematic structure of the ink cartridge 30 that stores the ink will be described.

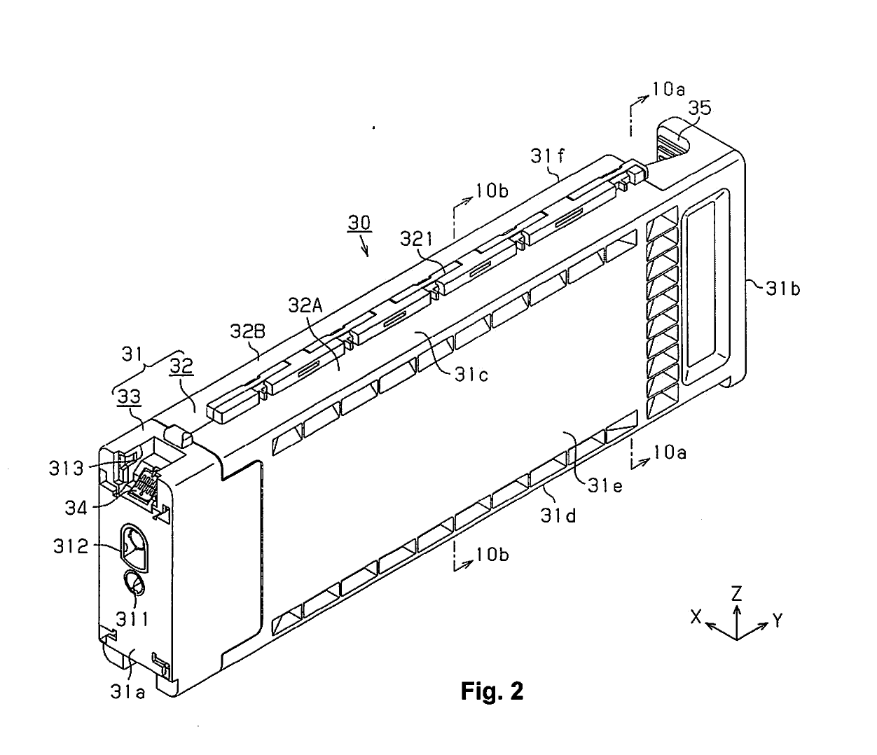

As shown in FIG. 2, the ink cartridge 30 is provided with an approximately rectangular shape case member 31 made of synthetic resin. The case member 31 has a longer length in the Z-direction along the gravity direction than the length of the X-direction which is a direction arranging a plurality of ink cartridges 30 when the plurality of cartridges 30 are mounted in the installation section 20 of the printer 11. In addition, it has a box shape which has a longer length in Y-direction along the inserting and ejecting direction of the ink cartridge 30 with respect to the installation section 20 than the length of the Z-direction. The case member 31 is provided with a main case 32 that the inside is hollow and the back side, which is a direction (−Y-direction) opposed to the +Y-direction, is open, and a subcase 33 which is provided so as to block the opening.

The case member 31 is provided with the first surface 31a that is a surface along the X-direction, which is the bottom surface of the subcase 33, and the Z-direction, the second surface 31b that is a surface opposed to the first surface 31a in the Y-direction, and the four surfaces of the third surface 31c, the fourth surface 31d, the fifth surface 31e, the sixth surface 31f that intersect with the first surface 31a and the second surface 31b. In a case that the Y-direction side (+Y-direction), which is near side for the user, is defined as the front side when the ink cartridge 30 is inserted to the installation section 20 from the front surface side (+Y-direction) of the printer 11, the first surface 31a of the case member 31 becomes the back surface in the position of the −Y-direction side, and on the other hand, the second surface 31b of the case member 31 becomes the front surface in the position of the +Y-direction. Further, the third surface 31c, which is a surface of the +Z-direction side in a state that it is mounted in the installation section 20, becomes the upper surface, and the fourth surface 31d, which is a surface of the gravity direction (−Z-direction side), that is, the direction opposed to the +Z-direction, becomes the lower surface. Among the two surfaces opposed to the right-and-left direction along the X-direction when viewing from the front side which is the Y-direction side, the fifth surface 31e, which is positioned in the left side (−X-direction side), becomes the left side surface, and the sixth surface 31f, which is positioned in the right side (+X-direction side) becomes the right side surface. It specifies that the direction from the first surface 31a to the second surface 31b is defined as +Y direction, the direction from the second surface 31b to the fourth surface 31a is defined as −Y direction, the direction from the third surface 31c to the fourth surface 31d is defined as −Z-direction, the direction from the fourth surface 31d to the third surface 31c is defined as +Z-direction, the direction from the fifth surface 31e to the sixth surface 31f is defined as +X-direction, and the direction from the sixth surface 31f to the fifth surface 31e is defined as −X-direction. Also, the first surface 31a and the second surface 31b are opposed in the Y-direction, and the third surface 31c and the fourth surface 31d are opposed in the Z-direction, and the fifth surface 31e and the sixth surface 31f are opposed in the X-direction.

In the first surface 31a of the case member 31, which is the bottom surface of the subcase 33, a rod insertion hole 311 and a supply tube insertion hole 312 (openings) are formed. When the ink cartridge 30 is inserted and mounted in the installation section 20, the positioning of the ink cartridge 30 is performed by inserting a rod (not shown) provided in the installation section 20 side in the rod insertion hole 311. On the other hand, in the supply tube insertion hole 312, an ink supply tube (not shown) such as an ink supply needle, etc. provided in the installation section 20 side is inserted. The ink supply tube is connected to the liquid ejecting head 18 through the ink supplying tube TB (see FIG. 1) that is pulled around in the frame 12 of the printer 11. Therefore, by inserting the ink supply tube into the supply tube insertion hole 312, it is possible to supply the ink from the ink cartridge 30 to the liquid ejecting head 18. The direction of the supply of the ink is the direction along the Y-direction.

Further, as shown in FIG. 2, in the corner section in the +Z-direction side of the subcase 33 that reaches to the deepest part (−Y-direction) of the installation section 20 when the case member 31 is inserted to the installation section 20, a recessed section 313 having an inclined surface is formed, and a substrate 34 is disposed on the inclined surface in the recessed section 313. When the ink cartridge 30 is mounted in the installation section 20, the substrate 34 is electrically connected to a substrate (not shown) provided in the installation section 20 side so that the exchange of various information such as an ink type, a remaining ink amount, etc. can be performed with the control section (not shown) of the printer 11. In one side surface (the sixth surface 31f that is the right side surface in FIG. 2) of the end part of the +Y-direction side of the case member 31, which is the near side for the user when the case member 31 is inserted to the installation section 20, a handle 35, which makes the ink cartridge 30 easy to be held, is formed.

As shown in FIG. 2 to FIG. 4, the main case 32 is provided with the first case body 32A positioned in the left side (−X-direction side) of the right-and-left direction (X-direction) and the second case body 32B positioned in the right side (+X-direction side) when viewing from the front side which is the +Y-direction side in a state that it is mounted in the installation section 20. In a state that the case member 31 is mounted in the installation section 20, the first case body 32A and the second case body 32B are respectively formed in an approximate box shape with a bottom where the respective approximate rectangular shaped side surfaces (the fifth surface 31e and the sixth surface 31f) along the Y-direction and the Z-direction are the bottom surface. The first case body 32A and the second case body 32B form the main case 32 in which the opening is formed in the back side, which is the −Y-direction side, by combining the opening edges each other in a state that the bottom surfaces are opposed to each other.

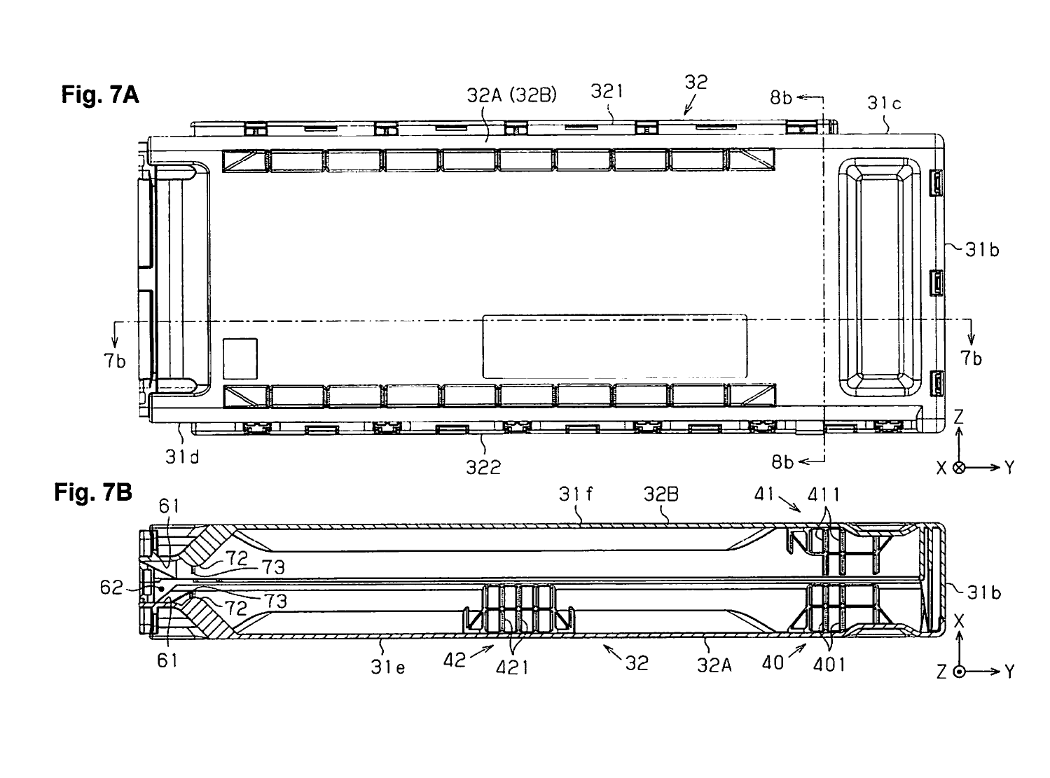

Further, in the upper surface (the third surface 31c) of the +Z-direction side in the main case 32, the rail section 321 is formed along the Y-direction which is the inserting and ejecting direction to the installation section 20. In addition, in the lower surface (fourth surface 31d) which is the surface of the lower side (−Z-direction side) in a direction opposed to the +Z-direction in the main case 32, in the same manner as the case in the upper surface, a rail section 322 (see FIG. 7A) is formed along the Y-direction which is the inserting and ejecting direction to the installation section 20. When the ink cartridge 30 is inserted to the installation section 20 of the printer 11, these rail sections 321, 322 guide the insertion of the ink cartridge 30 in slide contact with the guide rail section (not shown) provided in the installation section 20 side.

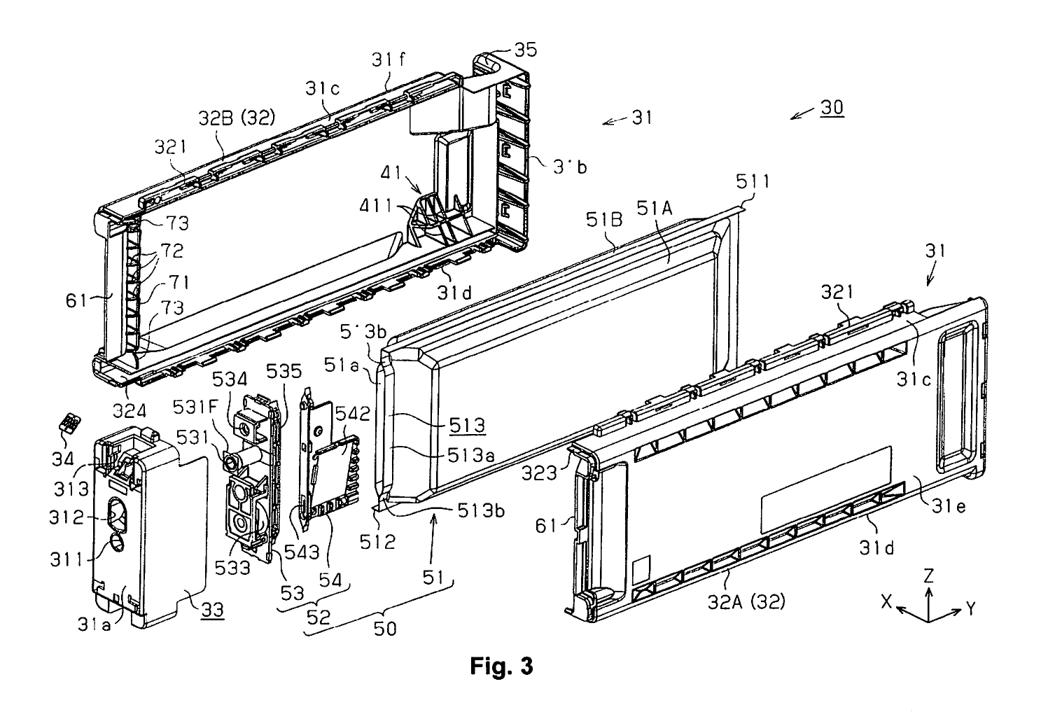

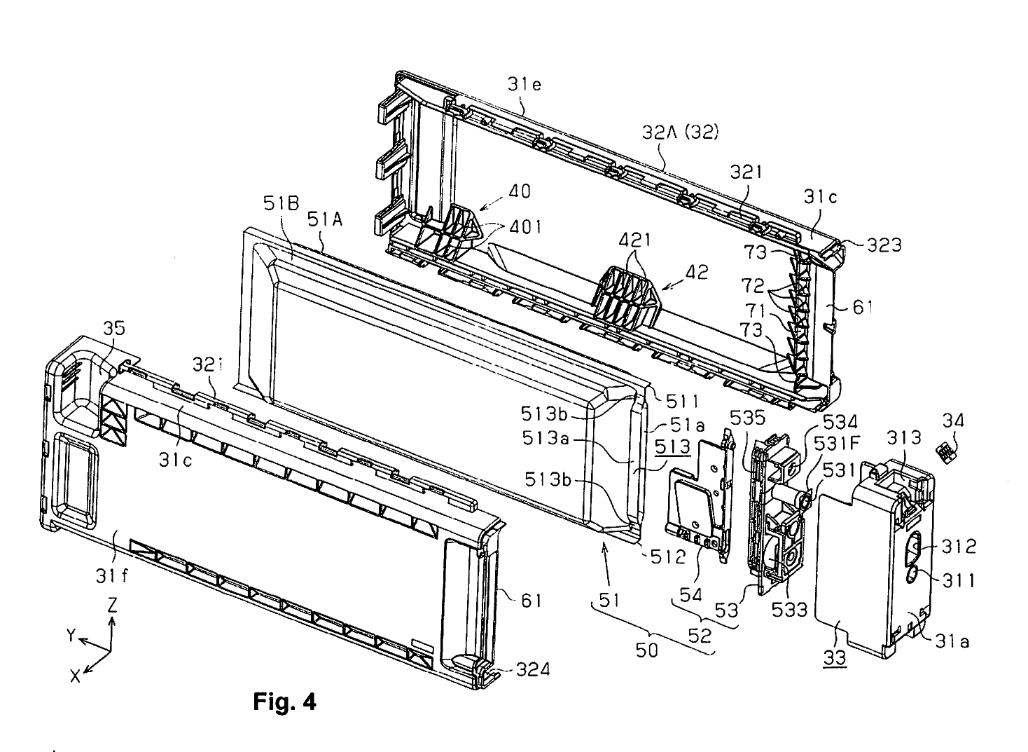

As shown in FIG. 3 and FIG. 4, an ink pack 50 in which the ink is storable is contained in the case member 31. The ink pack 50 is configured by a flexible bag-shaped pack body 51 capable of storing the ink, and a supply member 52 capable of supplying the ink in a pack body 51 to the outside. The opening edge 51a of the pack body 51 and the supply member 52 are bonded by, for example, the heat-welding. In the supply member 52, the first supply member 53 and the second supply member 54 are connected and integrated.

The pack body 51 is formed in a bag shape, so-called pillow-type ink bag, by the heat-welding, etc. to bond the edge parts of three sides other than a part of one side in −Y-direction side where an opening edge 51a of the pack body 51 is formed by the rectangular shaped first sheet material 51A and second sheet material 51B made of the flexible resin film, etc. The upper side of the edge part 511, which is the long side of the +Z-direction side in the pack body 51, is bent to the −X-direction so as to be formed along the Y-direction. The lower side of the edge part 512, which is the long side of the −Z-direction side in the pack body 51, is also bent to the +X-direction so as to be formed along the Y-direction in the same manner. In the pack body 51, the opening edge 51a becomes a joint section 513 with a bonded surface 535 in the supply member 52 side. The joint section 513 is configured by the first joint section 513a bonded along the Z-direction intersecting with the Y-direction which is the direction to supply the ink, and the second joint section 513b bonded along the Y-direction which is the direction to supply the ink.

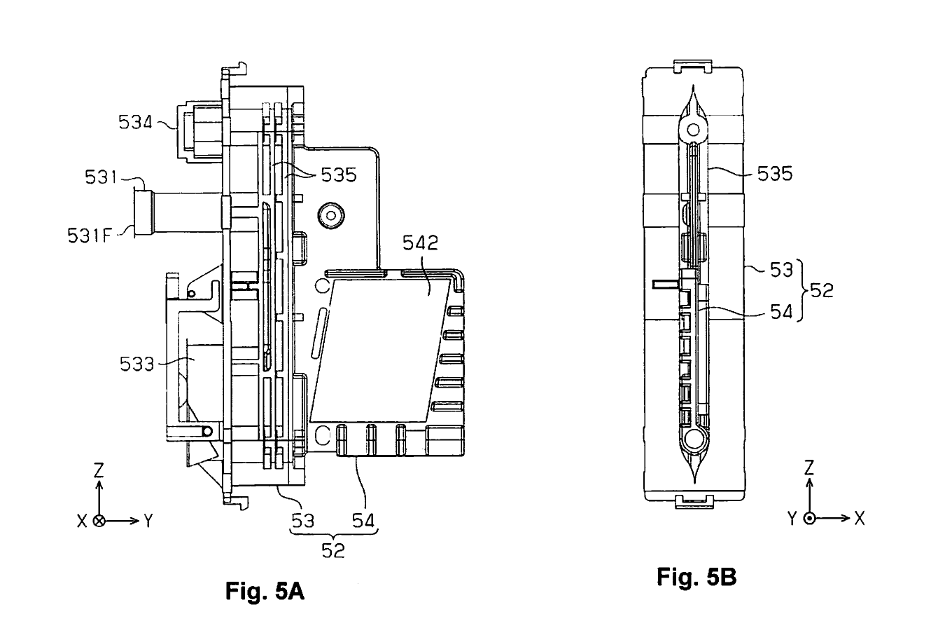

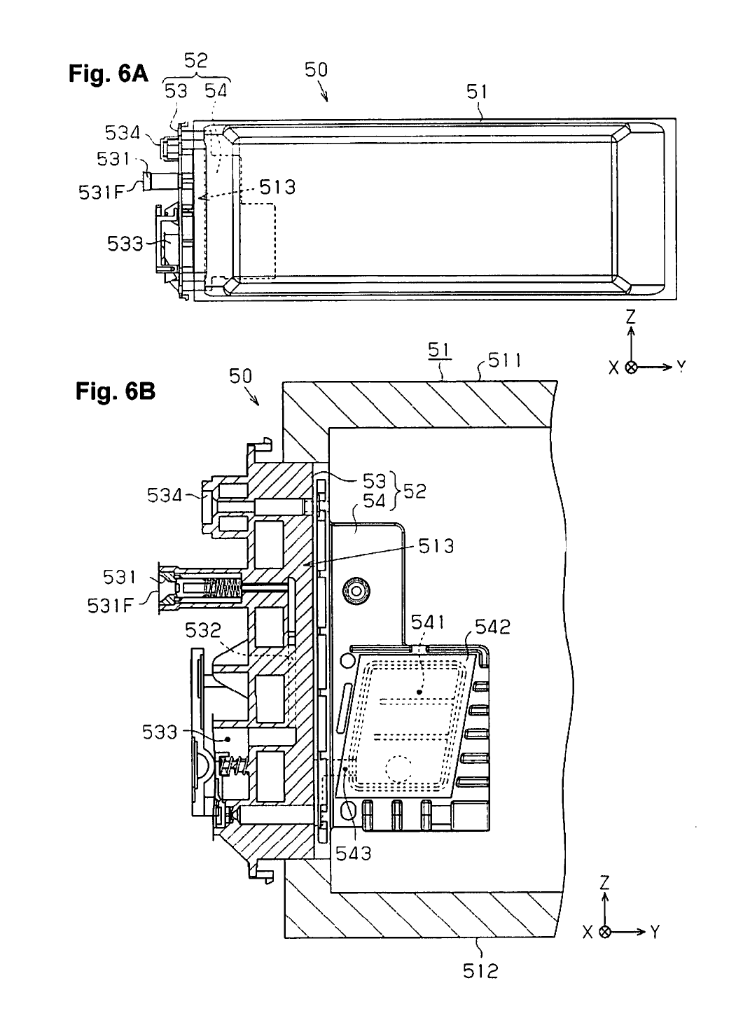

On the other hand, as shown in FIGS. 5A and 5B and FIGS. 6A and 6B, in a state of bonding to the pack body 51, the supply member 52 has a structure where the first supply member 53 that most of it is positioned in the outside of the pack body 51, and the second supply member 54 that most of it is positioned in the inside of the pack body 51 are bonded. When the ink in the pack body 51 is supplied to the first supply member 53 side, the second supply member 54 is the member having a function to collect foreign substances, etc. when the ink is passed through it. An opening of a filter room 541 (see FIG. 6B) formed as a groove on the left side surface which is the surface of the −X-direction side of the second supply member 54 is covered by the filter 542 made of, for example, a sheet-shaped fiber material. Further, in the inside of the second supply member 54, an ink flow channel 543 that the ink flowed in the filter room 541 through the filter 542 from the pack body 51 is made to flow to the first supply member 53 side is formed.

On the other hand, in the first supply member 53, a supply port 531 to supply the ink, which is flowed in through the ink flow channel 543 of the second supply member 54, to the outside is provided to open toward the −Y-direction side. In this supply port 531, when the ink cartridge 30 is mounted to the installation section 20 of the printer 11, the ink supply tube provided in the installation section 20 side is connected. That is, the supply port 531 is exposed to the outside of the case member 31 through the supply tube insertion hole 312 formed in the first surface 31a of the case member 31. In this point, the supply tube insertion hole 312 functions as the opening section in the manner that the supply port 531 of the supply member 52 in the ink pack 50 contained in the case member 31 is exposed to the outside. In the supply port 531, a sealing film 531F is bonded.

Further, in the first supply member 53, an ink flow channel 532 (see FIG. 6B) to flow the ink, which is flowed in through the ink flow channel 543 of the second supply member 54, to the supply port 531 side is formed. In the middle of the ink flow channel 532, an ink detection room 533, which is used for detecting the remaining amount of the ink in the pack body 51, is provided. Also, in the surface of the −Y-direction side in the first supply member 53, an ink filling opening 534, which is used when the ink is filled from the outside to the pack body 51 that an ink room is formed in the inner part by connecting the supply member 52 to the opening edge 51a, is provided. In the Y-direction side in the first supply member 53, that is, the side where it is connected to the second supply member 54, a bonded surface 535 to be inserted to the inside of the opening edge 51a of the pack body 51 and to be connected with the joint section 513 of the pack body 51 by the heat-welding etc. is provided.

As shown in FIG. 3 and FIG. 4, the first groove 323 is formed to be extended along the Y-direction in the edge part of the +Z direction side in the main case 32 of the case member 31. The first groove 323 is a trench shape that opens in the +X-direction side and the −Y-direction side in the edge part of the +Z-direction in the first case body 32A. When the pack body 51 is inserted to the inside of the main case 32 from the −Y-direction side, the edge part 511 in the upper side of the pack body 51 is inserted to the first groove 323. In the same manner, the second groove 324 is formed to be extended along the Y-direction in the edge part of the −Z-direction side in the inside of the main case 32 of the case member 31. The second groove 324 is a trench shape that opens the −X-direction side and the −Y-direction side in the edge part of the −Z-direction in the inside of the second case body 32B. When the pack body 51 is inserted to the inside of the main case 32 from the −Y-direction side, the edge part 512 in the lower side of the pack body 51 is inserted to the second groove 324.

Further, as shown in FIG. 4, in the part that is the edge part of the −Z-direction side in the first case body 32A of the main case 32 and the edge part of the +Y-direction side, a plurality of inclined ribs 40 (four inclined ribs in the present embodiment) is formed. The inclined ribs 40 are configured by an inclined section 401 that connects one end, which is positioned in the inside of the fourth surface 31d, to the other end, which is positioned in the inside of the fifth surface 31e in the +Z-direction than the one end and in the −X-direction side. In the same manner, as shown in FIG. 3, a plurality of inclined ribs 41 (three inclined ribs in the present embodiment) is formed in the part that is the end part of the −Z-direction side in the second case body 32B of the main case 32 and the end part of the +Y-direction side. The inclined ribs 41 is configured by an inclined section 411 that connects one end positioned in the inside of the fourth surface 31d to the other end positioned in the inside of the sixth surface 31f and in the +Z direction side than the one end and in the +X-direction side. In the position of these inclined ribs 40, 41 when the ink cartridge 30 is used, that is, the third surface 31c, which is the upper surface of the case member 31, positioned in the +Z-direction side, each of the inclined ribs 40, 41 is the rib that is inclined with respect to the gravity direction (−Z-direction). Each of the inclined sections 401, 411 functions as a contact section that is supportable for the pack body 51 in a state that it is contacted from the direction opposed to the gravity direction to the pack body 51 of the ink pack 50 contained in the inside of the case member 31.

Further, as shown in FIG. 4, in the part that is the end part of the −Z-direction side in the first case body 32A of the main case 32 and approximately the middle of the Y-direction, a plurality of inclined ribs 42 (five inclined ribs in the present embodiment) is formed. The inclined ribs 42 are configured by an inclined section 421 that connects one end positioned in the inside of the fourth surface 31d to the other end positioned in the inside of the fifth surface 31e of the −X-direction side and the +Z-direction side than the one end in the inside of the fifth surface 31e. In the position of these inclined ribs 42 when the ink cartridge 30 is used, the inclined section 421 becomes ribs inclined to the gravity direction (−Z-direction). The inclined section 421 functions as a contact section that is supportable for the pack body 51 in the state that it is contacted from the direction opposed to the gravity direction with respect to the pack body 51 in the ink pack 50 contained in the inside of the case member 31. The inclined ribs 42 provided in the end part of the −Z-direction side in the first case body 32A and approximately in the middle of the Y-direction are not provided in the second case body 32B.

In addition, as shown in FIGS. 7A and 7B and FIGS. 8A and 8B, in the end part of the −Y-direction side in the first case body 32A of the main case 32, an opening wall section 61, which forms a vertically long plain surface along the Z-direction and the Y-direction, is formed. In the same manner, in the end part of the −Y-direction side in the second case body 32B of the main case 32, the opening wall section 61, which forms a vertically long plain surface along the Z-direction and the Y-direction, is formed. In a state that the ink pack 50 is contained in the main case 32, these two opening wall sections 61 are opposed through the supply member 52, and the distance between these opening wall sections 61 is larger than the external diameter of the member (e.g., cylindrical-shaped member) that forms the supply port 531.

Further, as shown in FIG. 3 and FIG. 4, in the position of the +Y-direction side than the opening wall section 61 in the end part of the −Y-direction side in the first case body 32A of the main case 32, a plate-shaped longitudinal rib 71 along the Z-direction and the X-direction is formed. In the same manner, in the position of the +Y-direction than the opening wall section 61 in the end part of the −Y-direction side in the second case body 32B of the main case 32, the plate-shaped longitudinal rib 71 along the Z-direction and the X-direction is formed. As shown in FIGS. 8A and 8B, these longitudinal ribs 71 are opposed through the pack body 51 in a distance shorter than the distance between the two opening wall sections 61.

As shown in FIG. 3, FIG. 4, FIG. 8A, and FIG. 8B, a plurality of horizontal ribs 72 (8 horizontal ribs in the present embodiment) is formed with an interval in the Z-direction to each of the longitudinal ribs 71 of the first case body 32A and the second case body 32B. A shape of the horizontal ribs 72 has a surface along the Y-direction and the X-direction, and the horizontal ribs 72 are formed in the manner that the horizontal ribs 72 formed in the longitudinal ribs 71 of the first case body 32A and the horizontal ribs 72 formed in the second case body 32B are opposed through the pack body 51. As shown in FIG. 7B, each of the horizontal ribs 72 is an approximate triangular shape in which the tip is a circular arc. The tip having the circular arc is positioned in the opposite side (+Y-direction side) to the supply port 531 when viewing from the joint section 513, and is the shape along the outer surface of the pack body 51. When one of the horizontal ribs 72 provided in the first case body 32A is defined as the first rib, the second rib opposed to the first rib through the pack body 51 is provided in the second case body 32B. The first opposing section can be formed by combining the first rib and the second rib.

Further, in the position of the +Z-direction side than the longitudinal rib 71 of the first case body 32A, the third rib, which is the plate-shaped end rib 73 along the Z-direction and the X-direction, is provided. Also, in the position of the +Z-direction side than the longitudinal rib 71 of the second case body 32A, the fourth rib, which is the plate-shaped end rib 73 along the Z-direction and the X-direction is provided in the manner of being opposed to the third rib through the pack body 51. That is, these end ribs 73 and the horizontal ribs 72 are provided in the manner of being opposed to each other and protruding toward the pack body 51 from the fifth surface 31e side and the sixth surface 31f side which are the two surfaces intersecting with the gravity direction in the position when the ink cartridge 30 is used in the manner that the third surface 31c of the case member 31 is the upper surface. It is formed in the manner that the distance between the third rib and the fourth rib is shorter than the distance between the first rib and the second rib. The second opposing section can be formed by combining the third rib and the fourth rib.

In the present embodiment, the third rib and the fourth rib are provided not only in the +Z-direction side (third surface 31c side), but also in the −Z-direction side (fourth surface 31d side).

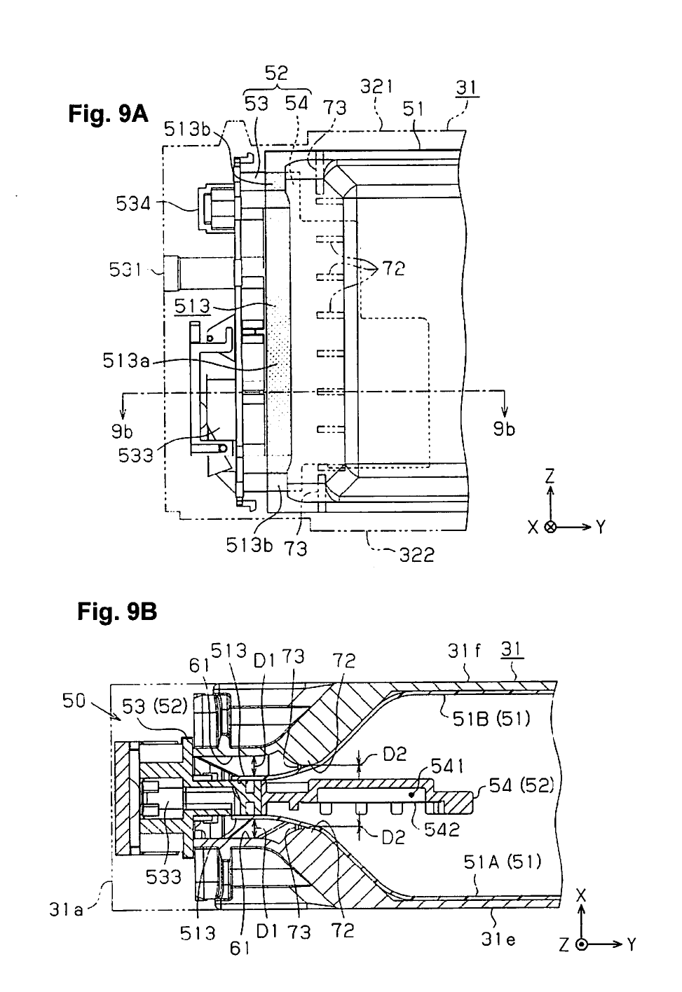

As shown in FIGS. 9A and 9B, when viewing the direction (+Y-direction) of the joint section 513 of the pack body 51 from the supply port 531 side of the first supply member 53, in at least one portion including the position where it is overlapped with the joint section 513 of the pack body 51, the horizontal ribs 72 and the end ribs 73 are provided in the manner of being protruded toward the outer surface side of the pack body 51 from the inner surface side of the case member 31. These opposed horizontal ribs 72 each other and the opposed end ribs 73 each other in the same manner are supported in a state that the outer surface part of the pack body 51 positioned in the opposite side (+Y-direction side) of the supply port 531 when viewing from the joint section 513 in the pack body 51 of the ink pack 50 is sandwiched by the both sides that intersect with the gravity direction.

As shown in FIG. 9B, in the inside of the case member 31, the ink pack 50 is contained in a state that the joint section 513 between the opening edge 51a of the pack body 51 and the bonded surface 535 of the supply member 52 is away from the opening wall section 61 of the case member 31 side, that is, in the manner of being opposed to the opening wall section 61 in the first distance D1.

Further, in this case, in the inside of the case member 31, the ink pack 50 is contained in a state that the outer surface part of the pack body 51 positioned in the opposite side (+Y-direction side) of the supply port 531 of the first supply member 53 when viewing from the joint section 513 in the pack body 51 is contacted to the horizontal ribs 72 and the end ribs 73 of the case member 31 side. In this point, the horizontal ribs 72 and/or the end ribs 73 in the case member 31 are opposed in the second distance D2 (the distance is zero in this case), which is shorter than the first distance D1, to the outer surface part of the pack body 51.

In the present embodiment, a plurality of the horizontal ribs 72 and the end ribs 73 are respectively provided, and they are provided so as to be opposed through the longitudinal ribs 71, the horizontal ribs 72, and the end ribs 73, but it is not limited to this. For example, it may be one horizontal rib 72 and one end rib 73, and the longitudinal rib 71, the horizontal rib 72, and the end rib 73 may not be provided in the opposite position.

Next, the function of the ink cartridge 30 with the aforementioned structure will be described.

The ink cartridge 30 is inserted from the first surface 31a which is the surface of the −Y-direction side of the case member 31, to the installation section 20 of the printer 11. Also, it is inserted in a state that the third surface 31c, which is the surface of the +Z-direction side, is positioned toward the upper side. In this case, in the inside of the case member 31, the ink pack 50 stably supported in a state that the flexible pack body 51 is sandwiched by the respective pairs of the horizontal ribs 72 and the end ribs 73 from the both sides (+X-direction, −X-direction) in the direction that intersects with the gravity direction (−Z-direction).

Further, when the ink is supplied to the outside from the ink cartridge 30 in the position of such use, the ink in the pack body 51 of the ink pack 50 is reduced, and the shape of the pack body 51 is changed. At this time, when the pack body 51 is the pillow-type pack body 51, specifically, there is a case that a bend section is formed toward the inner side from the outer side of the pack body 51 in the portion of the farther side (in this case, in the position near the +Y-direction side than the −Y-direction side in the pack body) from the supply port 531, and the gravity direction side (in this case, the position near the −Z-direction side than the +Z-direction side in the pack body). The ink is accumulated in such bend section so that it is preferable that the bend section is not formed. The occurrence of the formation of the bend section is not limited to the case that the ink is supplied to the outside, but it may occur in the case that the ink is filled to the pack body.

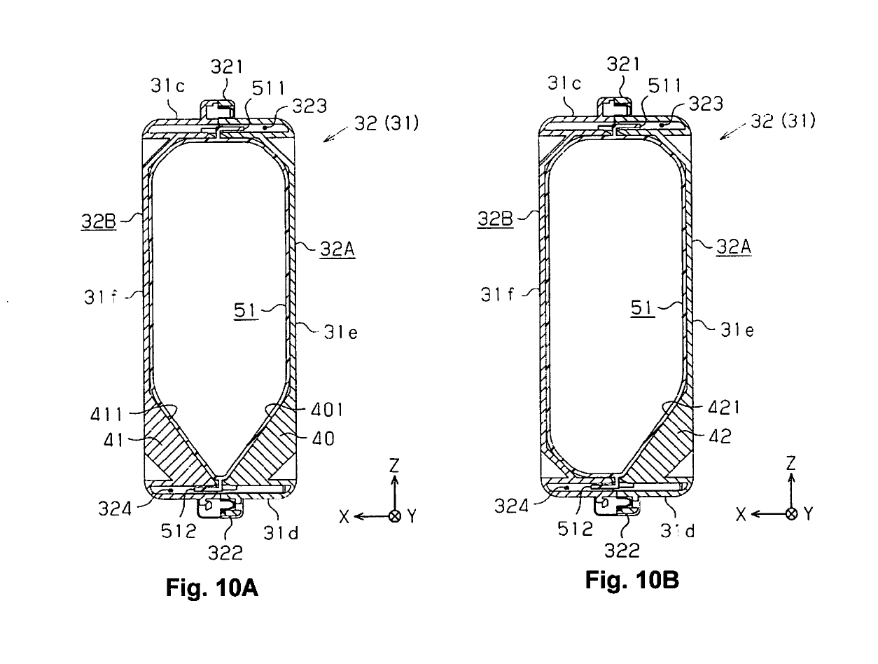

In this point, as shown in FIGS. 10A and 10B, in the present embodiment, the inclined sections 401, 411, 421 of the inclined ribs 40, 41, 42 are contacted from the direction opposed to the gravity direction (−Z-direction) to the outer surface part of the gravity direction side (in this case, the position near the −Z-direction side than the +Z-direction side in the pack body) including the end part of the +Y-direction side which is the farther side from the supply port 531 of the pack body 51 (in this case, the position near the +Y-direction side than the −Y-direction side in the pack body). Therefore, the pressurizing force is applied from the inclined sections 401, 411, 421, of the inclined ribs 40, 41, 42 to the pack body 51 so that it is prevented from forming the bend section. That is, the formation of the bend section can be prevented beforehand.

When the ink cartridge 30 is fallen down, etc., the ink in the ink pack is oscillated in accordance with the oscillation of the ink pack 50. There is a possibility that the bonding between the pack body 51 and the supply member 52 is peeled off due to such oscillation of the ink, so that it is preferably suppressed. In this point, in the present embodiment, such oscillation of the ink can be suppressed by contacting the horizontal ribs 72 and the end ribs 73 to the outer surface of the pack body 51. That is, the horizontal ribs 72 and the end ribs 73 function as the oscillation suppressing section to suppress the oscillation of the ink.

According to the present embodiment, the following effects can be obtained.

(1) For example, when the impact is given due to the falling down of the ink cartridge 30, etc., the ink contained in the ink pack 50 is oscillated in accordance with the oscillation of the ink pack 50 contained in the case member 31. There is a possibility that the bonding between the pack body 51 and the supply member 52 is peeled off due to the oscillation of the ink. However, in the present embodiment, the opposing section positioned in the opposite side (+Y-direction side) from the supply port 531 of the first supply member 53 when viewing from the joint section 513 and opposed through the pack body 51 is contacted to the pack body 51. Accordingly, propagating the oscillation of the ink to the joint section 513 can be suppressed. Therefore, since the peeling off of the joint section 513 caused by the leakage of the ink from the inside of the ink pack 50 can be suppressed, the reduction of the ink amount that can be supplied to the outside from the inside of the ink pack 50 contained in the case member 31 can be suppressed.

(2) Since the shape of the opposing section is a circular arc, even though the opposing section is contacted to the pack body 51, the damage of the pack body 51 can be reduced. As a result, the possibility of the leakage of the ink to the outside due to the breakage of the pack body 51, etc. can be suppressed.

(3) Further, when viewing the direction (+Y-direction) of the joint section 513 from the supply port 531 side, in at least a part including the position overlapped with the joint section 513, the opposing section is contacted with the pack body 51. Therefore, even when the ink in the pack body 51 is oscillated and flows toward the joint section 513 between the pack body 51 and the supply member 52 along the inner surface of the pack body 51, the flow of the ink can be blocked by the opposing section. Accordingly, the easiness of peeling off the bonding of the joint section 513 by such flow of the ink can be suppressed.

(4) The flexible pack body 51 of the ink pack 50 in the case member 31 can be stably supported by the horizontal ribs 72 and the end ribs 73, which are opposing section, in a state that it is sandwiched from the both sides in the direction intersecting the gravity direction.

(5) Further, the opposing section has the first opposing section that is provided with the first rib, which is one of the horizontal ribs 72 provided in the first case body 32A, and the second rib, which is provided in the second case body 32B and opposed through the first rib and the pack body 51. In addition, as the second opposing section, it is provided with the third rib, which is one of the end ribs 73 provided in the second case body 32B, and the fourth rib, which is provided in the second case body 32B and opposed through the third rib and the pack body 51. The first opposing section is provided in the +Y-direction side of the first joint section 513a that is connected along the Z-direction intersecting the Y-direction which is the direction that the ink is supplied in the joint section 513. The second opposing section is provided in the +Y-direction of the second joint section 513b that is connected along the Y-direction which is the direction that the ink is supplied in the joint section 513. Further, it can be configured by forming in the manner that the distance between the third rib and the fourth rib is shorter than the distance between the first rib and the second rib. Since the second joint section 513b is formed along the Y-direction, which is the direction that the ink is supplied (the direction that the ink flows), the ink easily flows in the second joint section 513b than the first joint section 513a. However, the distance between the ribs configuring the second opposing section is shorter than the first opposing section so that the easiness of the peeling off of the second joint section 513b can be suppressed.

(6) The pack body 51 of the ink cartridge 30 is formed in a bag-shape by welding the peripheral edges of the two flexible sheet materials 51A, 51B except the opening edge 51a, which is connected to the supply member 52. In this case, the shape of the pack body 51 is changed in accordance with the supply of the ink to the outside. The bend section caused by the shape change leads to increase the remaining amount of the ink. In this point, in the present embodiment, there is a configuration that the inclined sections 401, 411, 421 of the inclined ribs 40, 41, 42 are contacted to the outer surface of the flexible pack body 51 from the direction opposed to the gravity direction. Therefore, the possibility of the occurrence of the bend section in the pack body 51 is suppressed, and the reduction of the ink amount, which is possible to supply to the outside from the ink pack 50 contained in the case member 31, can be suppressed.

The aforementioned embodiments may be modified to the following different embodiments.

In the aforementioned embodiments, the configuration of the opposing section may be other than the horizontal ribs 72 or the end ribs 73. For example, as long as the configuration that can suppress the oscillation by contacting to the outer surface of the pack body 51, the second opposing section may be formed in other convex shapes such as a hemispherical shape, a semicircle cylindrical surface shape, a columnar shape, etc.

In the aforementioned embodiments, the configuration of the opposing section may not be the same in the right-and-left direction along the X-direction. That is, as long as the outer surface of the pack body 51 is supported from the both sides, the configurations of one side and the other side may be different.

In the aforementioned embodiments, the shape of the tip of the horizontal ribs 72 configuring the opposing section may not be the circular arc. For example, as long as it is a curved shape, the tip becomes the shape which is along the swelling shape of the outer surface continued from the joint section 513 in the pack body 51, so that the damage given to the outer surface of the pack body 51 by the impact at the time of the falling down, etc. can be reduced in the same manner as the circular arc.

In the aforementioned embodiments, the opening wall section 61, which is opposed to the joint section 513 of the pack body 51, may not be a plain surface. That is, it may be acceptable as long as the configuration that it is positioned away from the joint section 513 between the pack body 51 and the supply member 52 in a state that the ink pack 50 is contained in the case member 31.

In the aforementioned embodiments, the end ribs 73 may be omitted, and the opposing section may be configured by only the horizontal ribs 72.

In the aforementioned embodiment, when the second distance D2 is the shorter distance than the first distance D1, the distance may not be zero. In this case, when the ink cartridge 30 is fallen down, etc., in the ink pack 50 in the case member 31, the impact is not given to the joint section 513, which is opposed to the opening wall section 61 in the first distance D1, and it is also absorbed by contacting the outer surface of the pack body 51, which is opposed to the horizontal ribs 72 in the second distance D2 that is shorter than the first distance D1. Therefore, the peeling off of the bonding part can be suppressed.

In the aforementioned embodiments, the supply member 52 may be configured by only the first supply member 53, and the second supply member 54 may be omitted.

In the aforementioned embodiments, the ink cartridge storing the ink, which is an example of liquid, is explained as an example of the liquid container, but in this case, the liquid may be a material that can be ejected by the liquid ejecting device such as the printer 11, etc. For example, the composition may be in a state of liquid phase, and it includes fluid such as high or low viscosity liquid body, sol, gel water, other inorganic solvent, organic solvent, solution, liquid resin, liquid metal (metallic melt), etc., and it is not only the liquid as a state of the composition, but also, the compositions that particles of functional materials made of solid materials such as pigment or metallic particles, etc. are dissolved, dispersed, or mixed with a solvent. Also, as a major example of the liquid, it may be the ink or the liquid crystal, etc. as described in the aforementioned embodiments. Here, the ink generally includes various liquid compositions of aqueous ink, oil ink, gel ink, hot-melt ink, etc.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A liquid container comprising:
a liquid containing body including
a liquid containing section configured to contain liquid, the liquid containing section being flexible and having a bag-shape, and
a supply member connected to the liquid containing section, the supply member having a supply port that is configured to supply the liquid from the liquid containing section to an outside; and
a case member configured to contain the liquid containing body;
the case member having a first surface in which an opening section is formed to expose the supply port, and a second surface opposed to the first surface,
when a direction in which the first surface and the second surface are opposed is a Y-direction, and a direction from the first surface to the second surface is a +Y-direction,
the case member further having opposing sections that are opposed through the liquid containing section and are configured to contact with the liquid containing section in a position of the +Y-direction than a joint section between the liquid containing section and the supply member.

2. The liquid container according to claim 1, wherein
a shape of the opposing sections is circular arc.

3. The liquid container according to claim 1, wherein
the opposing sections are configured to contact with the liquid containing section in at least a part including a position overlapped with the joint section in the +Y-direction.

4. The liquid container according to claim 1, wherein
the case member has four surfaces that are a third surface, a fourth surface, a fifth surface, and a sixth surface that intersect with the first surface and the second surface, and
the opposing sections protrudes to a side of the liquid containing section from two surfaces intersecting with a gravity direction, among the four surfaces.

5. The liquid container according to claim 1, wherein
the liquid is supplied to the outside from the liquid containing section along the Y-direction,
the joint section includes a first joint section which is formed in a Z-direction intersecting with the Y-direction, and a second joint section which is formed along the Y-direction,
the opposing sections include a first opposing section which contacts with the first joint section, and a second opposing section which contacts with the second joint section,
the first opposing section has a first rib and a second rib,
the second opposing section has a third rib and a fourth rib, and
a distance between the third rib and the fourth rib is shorter than a distance between the first rib and the second rib.

6. The liquid container according to claim 1, wherein
a contact section is provided in the case member, the contact section has a surface inclined with respect to the gravity direction in a position of the liquid container in use, and the contact section is configured to support the liquid containing section in a state that the surface is contacted, from a direction opposed to the gravity direction, to the liquid containing section of the liquid containing body contained in the case member.

7. A liquid container comprising:
a liquid containing body in which a supply member is connected to a liquid containing section configured to contain liquid, the liquid containing section being flexible and having a bag-shape, the supply member having a supply port configured to supply the liquid to an outside from an inside of the liquid containing section; and
a case member configured to contain the liquid containing body,
in the case member, the liquid containing body being contained in a manner that a joint section between the liquid containing section and the supply member is positioned away from an inner surface of the case member, and an oscillation suppressing section being provided toward an outer surface of the liquid containing section in a protruding condition, the oscillation suppressing section being configured to suppress an oscillation of the liquid containing section in the case member by contacting a part of an outer surface positioned in an opposite side of the supply port of the supply member as viewed from the joint section in the liquid containing section of the contained liquid containing body.

8. A liquid container comprising:
a liquid containing body including
a liquid containing section configured to contain liquid, the liquid containing section being flexible and having a bag-shape, and
a supply member having a flow channel configured to allow the liquid to flow and configured to supply the liquid from an inside of the liquid containing section to an outside by connecting with the liquid containing section in a state that the flow channel is arranged in a manner of striding over the inside and outside of the liquid containing section; and
a case member configured to contain the liquid containing body and having an opening section to expose, to an outside, one end of the flow channel in the supply member of the contained liquid containing body,
in the case member, the liquid containing body being contained in a manner that a joint section between the liquid containing section and the supply member is positioned away from an inner surface of the case member, and an oscillation suppressing section being provided toward an outer surface of the liquid containing section in a protruding condition, the oscillation suppressing section being configured to suppress an oscillation of the liquid containing section in the case member by contacting a part other than the joint section in the liquid containing section of the contained liquid containing body.
